(19) United States
(12) Patent Application Publication
(10) Pub. No.: US 2026/0148124 A1
(43) Pub. Date: May 28, 2026

(54) SYSTEMS AND METHODS FOR ORCHESTRATING ARTIFICIAL INTELLIGENT AGENTS

(71) Applicant: Cisco Technology, Inc., San Jose, CA (US)

(72) Inventors: Jeffrey M. Napper, Delft (NL); Marc Scibelli, Trumbull, CT (US); Hendrikus G. P. Bosch, Amstelveen (NL); Pete Rai, Egham (GB); Guillaume Sauvage de Saint Marc, Sevres (FR)

(21) Appl. No.: 18/958,543

(22) Filed: Nov. 25, 2024

(51) Int. Cl. G06N 20/00; G06F 8/77; G06F 9/54

(52) U.S. Cl. CPC G06N 20/00; G06F 8/77; G06F 9/54

(57) ABSTRACT

In one embodiment, a method includes accessing a plurality of requirements for an agentic application, inferring an execution flow corresponding to the agentic application based on the plurality of requirements using a pre-trained first model, where the execution flow includes a sequence of blocks connected by a graph from a start block to an end block, wherein each of the blocks is associated with an input, an output, and a functional intent, identifying subsets of the blocks that require corresponding efficacy measurement among the blocks belonging to the execution flow, wherein the subsets of the blocks comprise at least each individual block, associating a corresponding efficacy analysis function measuring efficacy with each of the subsets of the blocks, causing the agentic application to be deployed, receiving feedback generated based on operations of the deployed agentic application, and retraining the pre-trained first model using at least the received feedback.

### TECHNICAL FIELD

The present disclosure relates generally to artificial intelligence, and more particularly, to an artificial intelligent generation of an agentic application.

### BACKGROUND

An artificial intelligent (AI) agent is an agent that can solve complex goals (semi-) autonomously. The AI agent may perceive its environment, take actions autonomously in order to achieve goals. When deployed, a set of AI agents, possibly with callouts to application programming interface (API) services, and extended with regular non-AI code, work together to generate solutions to a stated problem, critiquing those solutions, and then collectively and by consensus generate an acceptable outcome to the stated problem as an agentic application. AI agents may be pre-canned, self-trained, generated, while using existing (foundational) models, by being specifically fine-tuned for use cases. Examples for AI applications range from automating software development, automating application operations and cloud security processes, implementing and maintaining cloud application operations, managing financial operations, handling customer management campaigns, organizing travel and healthcare, and much more. An AI assistant may be considered a simple AI agent. A full-blown AI agent may take its own decisions with the consent of humans but without any human supervision are on the other end of the scale.

At the time of writing this disclosure, a few frameworks enabling programmers to create agentic applications are existing. All these frameworks are, in essence, tools and hosting infrastructures for developers to build new agentic applications. The developer assembles new applications with newly defined agents and host these agentic apps in these frameworks. However, much of the agentic problem may be about interconnecting existing and new agents with existing applications, bringing regular applications, agents, processes and data together in an efficient manner. An agentic composition problem is about getting end-to-end agentic solutions evaluated, while keeping them safe and trustworthy. The agentic composition problem may present distinct challenges when compared to today's regular software development processes. Below is a list of some of the specific issues for composing agentic AI applications:
Deciding what set of agents to use for a particular use case.
How to prime or auto-generate those agents.
What models, prompts and Retrieval-Augmented Generations (RAGs) are used for what agents.
How to combine agents with dynamic data, other agents, and other (more traditional) software components of the application.
Where to run those agents? Centrally or distributed, close to the (dynamic) data or close to the rest of the app?
What protocols and communication mechanisms are needed between the components.
   Given that there are likely many possible outcomes which satisfy each use case, dynamically deciding which outcome works best for what (agentic) problems compounds the agentic composition problem.

### BRIEF DESCRIPTION OF THE DRAWINGS

FIG. 1 illustrates an example logical system architecture for autonomously inferring an executable agentic application from application requirements.

FIG. 2 illustrates an example cycle of developing an agentic application.

FIG. 3 illustrates an example method for developing an agentic application using a machine-learning model.

FIG. 4 illustrates an example computing system.

### DESCRIPTION OF EXAMPLE EMBODIMENTS

### OVERVIEW

In particular embodiments, a method, by a first computer system, may include accessing a plurality of requirements for an agentic application. The method may include inferring an execution flow corresponding to the agentic application based on the plurality of requirements using a pre-trained first model. The execution flow may include a sequence of blocks connected by a graph from a start block to an end block. In particular embodiments, the graph may be a direct acyclic graph. Each of the blocks may be associated with an input, an output, and a functional intent achieved by an API, an AI agent, an AI assistant, or a non-AI software component that is interacting with another non-AI software component, an API, an AI agent, or an AI assistant. In particular embodiments, a block may comprise another flow that may be a sequence of blocks. Therefore, a flow may be a block within a great flow. The method may include identifying subsets of the blocks that require corresponding efficacy measurement among the blocks belonging to the execution flow. The subsets of the blocks may include at least each individual block. The method may include associating a corresponding efficacy analysis function measuring efficacy with each of the subsets of the blocks. The method may include cause the agentic application to be deployed. The method may include receiving feedback generated based on operations of the deployed agentic application. The method may include retraining the pre-trained first model using at least the received feedback.

In particular embodiments, a first computer system may include one or more processors, and one or more computer-readable non-transitory storage media coupled to one or more of the processors. The one or more computer-readable non-transitory storage media may include instructions operable when executed by one or more of the processors to access a plurality of requirements for an agentic application. The processors are further operable when executing the instructions to infer an execution flow corresponding to the agentic application based on the plurality of requirements using a pre-trained first model. The execution flow may include a sequence of blocks connected by a graph from a start block to an end block. In particular embodiments, the graph may be a direct acyclic graph. Each of the blocks may be associated with an input, an output, and a functional intent achieved by an API, an AI agent, an AI assistant, or a non-AI software component that is interacting with another non-AI software component, an API, an AI agent, or an AI assistant. In particular embodiments, a block may comprise another flow that may be a sequence of blocks. Therefore, a flow may be a block within a great flow. The processors are further operable when executing the instructions to identify subsets of the blocks that require corresponding efficacy measurement among the blocks belonging to the execution flow. The subsets of the blocks may include at least each individual block. The processors are further operable when executing the instructions to associate a corresponding efficacy analysis function measuring efficacy with each of the subsets of the blocks. The processors are further operable when executing the instructions to cause the agentic application to be deployed. The processors are further operable when executing the instructions to receive feedback generated based on operations of the deployed agentic application. The processors are further operable when executing the instructions to retrain the first model using at least the received feedback.

In one or more embodiments, one or more computer-readable non-transitory storage media may embody software that is operable, when executed by a first computer system, to access a plurality of requirements for an agentic application. The software may be further operable when executed by the first computer system to infer an execution flow corresponding to the agentic application based on the plurality of requirements using a pre-trained first model. The execution flow may include a sequence of blocks connected by a graph from a start block to an end block. In particular embodiments, the graph may be a direct acyclic graph. Each of the blocks may be associated with an input, an output, and a functional intent achieved by an API, an AI agent, an AI assistant, or a non-AI software component that is interacting with another non-AI software component, an API, an AI agent, or an AI assistant. In particular embodiments, a block may comprise another flow that may be a sequence of blocks. Therefore, a flow may be a block within a great flow. The software may be further operable when executed by the first computer system to identify subsets of the blocks that require corresponding efficacy measurement among the blocks belonging to the execution flow. The subsets of the blocks may include at least each individual block. The software may be further operable when executed by the first computer system to associate a corresponding efficacy analysis function measuring efficacy with each of the subsets of the blocks. The software may be further operable when executed by the first computer system to cause the agentic application to be deployed. The software may be further operable when executed by the first computer system to receive feedback generated based on operations of the deployed agentic application. The software may be further operable when executed by the first computer system to retrain the first model using at least the received feedback.

In particular embodiments, a first computer system may access a plurality of requirements for an agentic application. In particular embodiments, the plurality of requirements for the agentic application may be generated by processing data corresponding to informal requirements for the agentic application. The data corresponding to the informal requirements for the agentic application may include notes, drawings, slides, formalized documents, compliance rules, or a piece of computer-interpretable code capturing proof-of-concept.

In particular embodiments, the first computer system may infer an execution flow corresponding to the agentic application based on the plurality of requirements using a pre-trained first model. The execution flow may include a sequence of blocks connected by a graph from a start block to an end block. Each of the blocks may be associated with an input, an output, and a functional intent achieved by an API, an AI agent, an AI assistant, or a non-AI software component that is interacting with another non-AI software component, an API, an AI agent, or an AI assistant.

In particular embodiments, the first computer system may identify subsets of the blocks that require corresponding efficacy measurement among the blocks belonging to the execution flow. In particular embodiments, the subsets of the blocks may include at least each individual block. In particular embodiments, the subsets of the blocks may include a group of blocks whose group efficacy may need to be measured.

In particular embodiments, the first computer system may associate a corresponding efficacy analysis function with each of the subsets of the blocks. Each subset of the blocks may be associated with a functional intent. An efficacy analysis function may evaluate the functional intent for the corresponding subset of blocks by measuring efficacy of the corresponding subset of blocks. In particular embodiments, an efficacy analysis function may produce a functional determination. In particular embodiments, an efficacy analysis function may produce non-functional assessments. The non-functional assessments may include, but not limited to, performance, power, latency, or any suitable non-functional assessment. In particular embodiments, the efficacy analysis function may be provided based on the functional intent for the corresponding subset of blocks. In particular embodiments, the efficacy analysis function may be inferred based on the functional intent for the corresponding subset of blocks.

In particular embodiments, the first computer system may send the one or more execution flows corresponding to the agentic application to the second computer system after associating a corresponding efficacy analysis function for each block and each group of blocks among selected groups of blocks.

In particular embodiments, a developer associated with the second computer system may provide the confirmation on the execution flow. In particular embodiments, the developer associated with the second computer system may modify a subset of the one or more execution flows before the developer sends the confirmation. In particular embodiments, the developer associated with a second computer system may use one or more tools for interacting with the first computer system. The tools may include a large language model (LLM), an Integrated Development Environment (IDE), or an IDE assistant. In particular embodiments, a second model trained to evaluate the one or more execution flows corresponding to the agentic application in relation to the plurality of requirements may provide the confirmation.

In particular embodiments, the first computer system may cause the agentic application to be deployed upon receiving the confirmation from the second computer system. In particular embodiments, the first computer system may receive feedback generated based on operations of the deployed agentic application. In particular embodiments, the feedback may include efficacy measurements generated by the efficacy analysis functions. In particular embodiments, the feedback may include structured feedback from one or more users of the deployed agentic application. In particular embodiments, the structured feedback may be a binary (yes/or) evaluation.

In particular embodiments, the first computer system may retrain the first model using at least the received feedback. In particular embodiments, retraining the first model may include performing a reinforcement learning based on the received feedback. In particular embodiments, the reinforcement learning may be further based on feedback previously received.

Technical advantages of certain embodiments of this disclosure may include one or more of the following. This disclosure describes systems and methods that autonomously infer an executable agentic application in a form of a set of application blocks from application requirements. This disclosure also describes systems and methods that associate individual or groups of blocks with efficacy analysis functions, which are also inferred from application requirements. This disclosure also describes systems and methods that learn from the efficacy analysis functions how well each individual block or group of blocks meet the corresponding intended original requirements when the application is in operation. This disclosure further describes systems and methods that train a model that infers an executable agentic application in a form of a set of application blocks from application requirements using efficacy measurements produced by the efficacy analysis functions.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

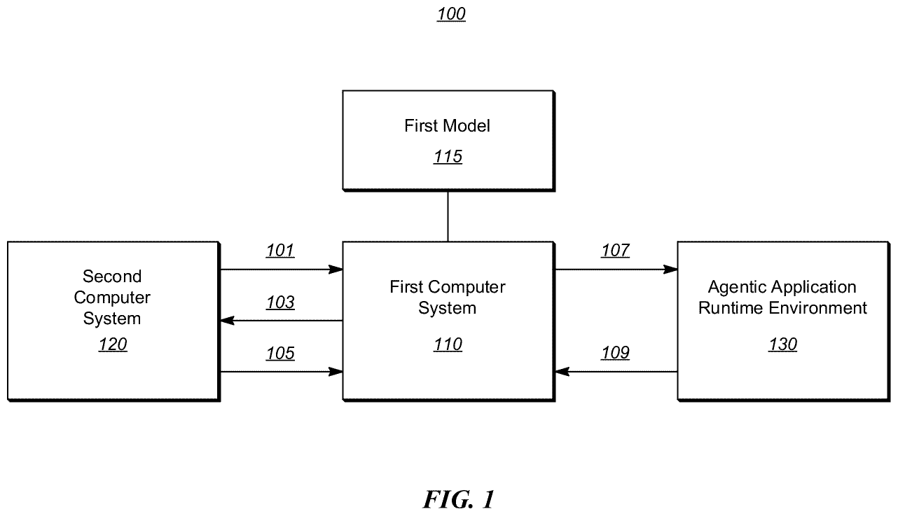

This disclosure describes systems and methods for autonomously inferring an executable agentic application from application requirements using a machine-learning model and for retraining the machine-learning model using efficacy measurements gathered while the executable agentic application is running. FIG. 1 illustrates an example logical system architecture 100 for autonomously inferring an executable agentic application from application requirements. A first computer system 110 may be associated with a first model 115. The first computer system 110 may receive a plurality of requirements for an agentic application at step 101 from a second computer system 120. Upon receiving the plurality of requirements, the first computer system 110 may infer an execution flow corresponding to the agentic application based on the plurality of requirements using the first model 115. The execution flow may include a sequence of blocks connected by graph from a start block to an end block. Each of the blocks may be associated with an input, an output, and a functional intent achieved by an API, an AI agent, an AI assistant, or a set of non-AI software components. The first computer system 110 may identify subsets of the blocks that require corresponding efficacy measurement among the blocks belonging to the execution flow. The first computer system 110 may associate an efficacy analysis function with each of the subsets of the blocks. The subsets of the blocks may include at least each individual block. Each subset of blocks may be associated with a functional intent. An efficacy analysis function may evaluate the functional intent for the corresponding subset of blocks by measuring efficacy of the corresponding subset of blocks. In particular embodiments, the efficacy analysis function may be provided based on the functional intent for the corresponding subset of blocks. In particular embodiments, the efficacy analysis function may be inferred based on the functional intent for the corresponding subset of blocks. At step 103, the first computer system 110 may send the one or more execution flows corresponding to the agentic application and the efficacy analysis functions corresponding to the selected subset of blocks belonging to the one or more execution flows to the second computer system 120. At step 105, the first computer system 110 may receive a confirmation on the execution flow from the second computer system 120. Upon receiving the confirmation, the first computer system may, at step 107, cause the agentic application to be deployed in an agentic application runtime environment 130. The agentic application runtime environment 130 may include one or more AI agents, AI assistants, sets of non-AI software components, or APIs performing functions for the agentic application. The one or more AI agents, AI assistants, sets of non-AI software components, or APIs are capable of communicating with each other. At step 109, the first computer system 110 may receive feedback from the agentic application runtime environment 130. The feedback may include efficacy measurements generated by the efficacy analysis functions. The feedback may also include structured feedback from one or more users of the deployed agentic application. After receiving the feedback at step 109, the first computer system 110 may retrain the first model using the received feedback. Although this disclosure describes a particular logical system architecture for autonomously inferring an executable agentic application from application requirements, this disclosure contemplates any suitable logical system architecture for autonomously inferring an executable agentic application from application requirements.

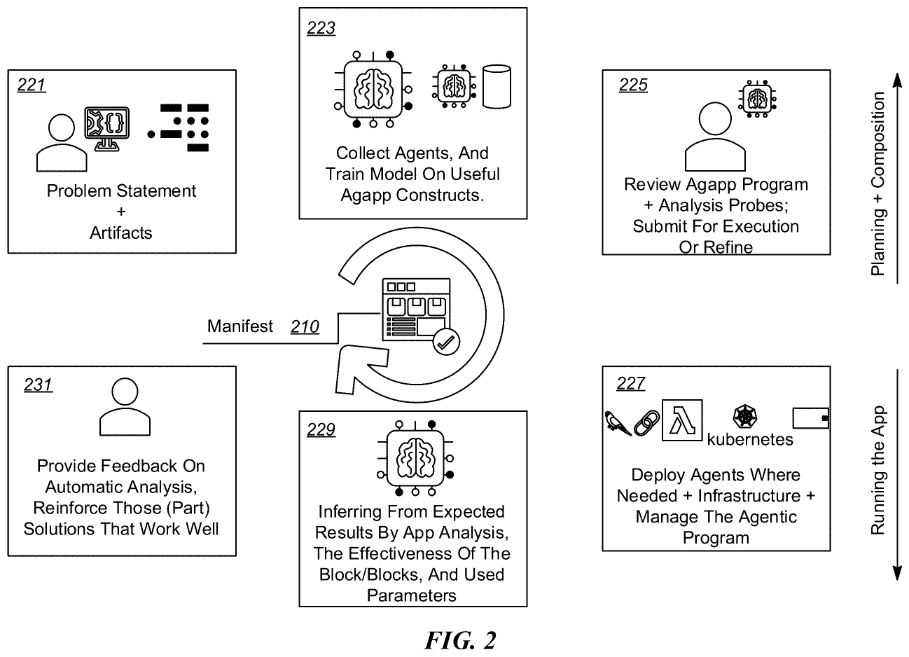

FIG. 2 illustrates an example cycle of developing an agentic application. An agentic application's manifest 210 may be a key element of developing the agentic application. The manifest 210 may be encoded as a structured document. The manifest 210 may have JavaScript Object Notation (JSON), Extensible Markup Language (XML) or YAML data structure that captures all aspects of the agentic application. In particular embodiments, running an agentic application may be materializing a manifest of the agentic application that can be executed through the agentic application runtime environment 130. An open communication channel where AI agents can post and read structured messages may exist in the agentic application runtime environment 130. The structure messages may be in a JSON, XML or YAML structure. An AI agent may receive a manifest, update the received manifest, and submit the updated manifest for further processing by any other agents. Although this disclosure describes communications between AI agents in a particular manner, this disclosure contemplates communications between AI agents in any suitable manner.

In particular embodiments, the first computer system 110 may access a plurality of requirements for an agentic application. In particular embodiments, the plurality of requirements may be represented in natural language. In particular embodiments, the plurality of requirements for the agentic application may be generated by processing data corresponding to informal requirements for the agentic application. The data corresponding to informal requirements for the agentic application may include notes, drawings, slides, formalized documents, compliance rules, or a piece of computer-interpretable code capturing proof-of-concept. As an example and not by way of limitation, a developer associated with the second computer system 120 may gather all aspects of an agentic application in stage 221. Artifacts describing the agentic application may be added to the manifest 210, with each set of requirements listed as outcomes. Materials, links to materials, and/or credentials required to access materials may be added into the manifest 210, wherein materials may include documents, drawings, slides, compliance rules, or a piece of computer-interpretable code. After gathering data into the manifest 210, the developer may post the manifest 210 with an indicator indicating that new requirements are posted. Although this disclosure describes accessing requirements for an agentic application in a particular manner, this disclosure contemplates accessing requirements for an agentic application in any suitable manner.

An agentic application may be an application that runs as one or more processes hosted by one or multiple tenants, on regular processors, and may be extended with GPU resources for ML functionality, combined with all the traditional (non-AI) software components, internal and external API services, and AI assistants, or AI agents. The agentic application may have an internal process structure where agents, assistants, API services, or non-AI software components interact with each other as independent processes.

An agentic application may be described by way of blocks. These blocks may be extended for capturing API services, AI assistants, or AI agents with all artifacts, such as prompts, RAGs, configuration parameters, etc. A set of these basic blocks, called a flow, connected in a directed graph may represent an abstract version of the agentic application. The set of blocks for an agentic application may be derived from the set of requirements of an application. The set of blocks and their relationship may be generated by a machine-learning model that converts those requirements into those blocks and their relationship.

The set of basic blocks and their association may be recorded in the manifest 210. Each essential component of the application may be captured by one or more blocks. Each block may have an input, an output and a functional intent. The input and output of a block may describe in detail how to pass state to the block and how the block passes state to the next block. The output of a first block must match the input of a second block when the first block and the second block are connected by a directed graph in a flow. Blocks or groups of blocks may be implemented as an independent agent or assistant.

A block may contain an API service, a set of non-AI software component, an assistant or agent. Control functionalities including conditional branches, loops, etc. between blocks may be possible. Each block may be described by way of a (natural language) description, and such descriptions capture all the essential artifacts necessary to make the block a functional (e.g., API credentials, agent/assistant generative information, etc.) element. In particular embodiments, blocks may have declared side-effects, while most blocks have no side effects. Certain blocks may be actuators instantiating real-world actions such as sending an email or booking a flight.

A sequence of blocks with a single “start” block and “end” block may be referred to as a flow, which may render an application use case. Error conditions may point to the “end” block. Parallel or distributed processing for an agentic application may be reflected through multiple “start/end” blocks with their own logic. An inter-process call, e.g., when agents/assistant interact with other agents/assistant between two threads of control may be identified by one block making a “remote” call to another flow. The control flow may be similar to traditional remote procedure calls or messages posted to pub/sub busses. Every agentic application may be captured by one or more application flows.

The agentic application's manifest 210 may captures all flows needed by the agentic application. The manifest 210 may be a unique yet condensed version of a fully instantiated and runnable app. The manifest 210 may capture a complete set of essential elements of the agentic application, what internal processes are needed, what internal and external resources are needed and what each block and set of blocks need to do. In particular embodiments, the manifest 210 may be captured in variety of declarative presentation formats such as JSON, YAML, XML, etc. One or more flows in the manifest 210 may be converted into an actual agentic application.

In particular embodiments, the first computer system 110 may infer an execution flow corresponding to the agentic application based on the plurality of requirements using a pre-trained first model 115. The execution flow may include a sequence of blocks connected by a graph from a start block to an end block. Each of the blocks may be associated with an input, an output, and a functional intent achieved by an API, an AI agent, an AI assistant, or a non-AI software component that is interacting with another non-AI software component, an API, an AI agent, or an AI assistant. In particular embodiments, the first computer system 110 may infer a plurality of flows corresponding to the agentic application based on the plurality of requirements using the pre-trained first model 115. As an example and not by way of limitation, when a manifest 210 is posted with an indicator that requirements have been changed in the manifest 210, an agent, in stage 223, may be activated to break the set of requirements posted in the manifest 210 into smaller sub-problems and establish a structure of the sub-problems needed to implement the requirements. In particular embodiments, the agent may use the first model 115 to convert global requirements in the manifest 210 into a more detailed set of requirements. In particular embodiments, the agent may use the first model 115 to convert the set of requirements to an abstract program of sub-problems. Each of the sub-problems may be broken down, when possible, into a sequence of blocks. A first block in the sequence may be labelled with ‘start.’ A last block in the sequence may be labelled with ‘end.’ When a first model 115 is not capable of breaking down the sub-problems into blocks, the developer may be asked to further detail the requirements in the manifest 210 during stage 225. Each sub-problem and block in the manifest 210 may be associated with the requirements for corresponding sub-problem/block. After converted requirements into a set of sub-problems, blocks and associated problem descriptions/requirements per sub-problem/block, the agent may use the first model 115 to match these sub-problems and blocks with agents, assistants, API services, or sets of non-AI software components available in a database associated with the first model 115. In particular embodiments, the first model 115 may search agents, assistants, API services, or sets of non-AI software components for a particular sub-problem or a block in real-time. When multiple options for APIs, agents, assistants, or sets of non-AI software components are viable, each of such options may be inserted into the manifest 210 with a measure for how well the use case description is covered by the API, agent, assistant, or a non-AI software component. Probabilities as presented out of the sigmoid function, the cosine similarity/Euclidean distance of their vector representations, or other measure may be used as an ordering mechanism. The manifest 210 may be altered to capture, per sub-problem/block, the relevant APIs, assistants, agents, or sets of non-AI software components with the ordering. In particular embodiments, the agent may use the first model 115 to add actual code for use of APIs, assistants, or agents in the manifest 210. The agent may also ensure that input and output of connected blocks in a flow match. In case the input and output of two connected blocks do not match, a translation block may be inserted between the two blocks. At the end of this process, the manifest 210 may describe one or more execution flows corresponding to the agentic application, in which each block may be associated with an input, an output, and a functional intent achieved by an API, an AI agent, an AI assistant, or a non-AI software component. All the artifacts corresponding agents or assistants, such as prompts, RAGs, configuration parameters, etc., may be captured in the manifest 210. Although this disclosure describes inferring an execution flow corresponding to an agentic application based on a plurality of requirements in a particular manner, this disclosure contemplates inferring an execution flow corresponding to an agentic application based on a plurality of requirements in any suitable manner.

In particular embodiments, the first computer system 110 may identify subsets of the blocks that require corresponding efficacy measurement among the blocks belonging to the execution flow. In particular embodiments, the subsets of the blocks may include at least each individual block. In particular embodiments, the subsets of the blocks may include a group of blocks whose group efficacy may need to be measured. As an example and not by way of limitation, an execution flow corresponding to an agentic application includes six blocks {a, b, c, d, e, f}. Because the efficacy of each block in the execution flow needs to be measured, the subsets of the blocks that require corresponding efficacy measurement may include {a}, {b}, {c}, {d}, {e}, and {f}. The first computing system 110 may identify a group of {a, b} as a subset of the blocks that require corresponding efficacy measurement because blocks a and b are supposed to work together for a group functional intent. Similarly, the first computing system 110 may identify groups {a, b, c} and {e, f} as subsets of the blocks that require corresponding efficacy measurement. At the end of identifying stage, the first computing system 110 may identify {a}, {b}, {c}, {d}, {e}, {f}, {a, b}, {a, b, c}, and {e, f} as subsets of the blocks that require corresponding efficacy measurement. Although this disclosure describes identifying subsets of the blocks that require corresponding efficacy measurement among the blocks belonging to the execution flow in a particular manner, this disclosure contemplates identifying subsets of the blocks that require corresponding efficacy measurement among the blocks belonging to the execution flow in any suitable manner.

The efficacy of each block must be measurable. In particular embodiments, the efficacy of a subset of the blocks in the subsets of the blocks among the blocks belonging to the execution flow may be measurable. The efficacy measurements may be used in assessing whether the first model 115 inferred the right set of blocks and flows for the requirements of the agentic application. The efficacy of a block is measurable by its pre-declared function. Its effectiveness may be captured through an analysis of the inputs and outputs relative to its intended function.

In particular embodiments, the first computer system 110 may associate a corresponding efficacy analysis function with each of the subsets of the blocks. The subsets of the blocks may include at least each individual block. Each subset of blocks may be associated with a functional intent. An efficacy analysis function may evaluate the functional intent for the corresponding subset of blocks by measuring efficacy of the corresponding subset of blocks. In particular embodiments, an efficacy analysis function may produce a functional determination. In particular embodiments, an efficacy analysis function may produce non-functional assessments. The non-functional assessments may include, but not limited to, performance, power, latency, or any suitable non-functional assessment. In particular embodiments, the efficacy analysis function may be provided based on the functional intent for the corresponding subset of blocks. In particular embodiments, the efficacy analysis function may be inferred based on the functional intent for the corresponding subset of blocks. As an example and not by way of limitation, the first computer system 110 may use the first model 115 to infer mechanisms to measure the efficacy of individual blocks in an execution flow. The first model 115 may infer the mechanisms based on the requirements, the block and flow structure, the mapping of the use cases derived from the requirements to each of the blocks. The mechanisms maybe described in an abstract form jointly with the objective of the measurement. A probe that measures the acceptability of each block's outcome may be included into the block. The probe may be referred to as an efficacy analysis function for the block. The first model 115 may identify each subset of the blocks whose efficacy may be measurable. A subset of the blocks may be a group of blocks. The first model 115 may infer mechanisms to measure the efficacy of each subset of the blocks. Each subset of blocks may be associated with an efficacy analysis function. Although this disclosure describes associating an efficacy analysis function with a subset of the blocks in a particular manner, this disclosure contemplates associating an efficacy analysis function with a subset of the blocks in any suitable manner.

When the performance metrics and probes are combined into more comprehensive probes, the objectives and measurement techniques may be combined into an aggregate objective and measurement probe. These comprehensive probes thus capture the behavior of the application and provide insights into how well the agentic application implements the agentic use case identified based on requirements. These comprehensive probes may measure the efficacy of the application to implement the application requirements. The comprehensive probes may be a set of efficacy analysis functions. In particular embodiments, the efficacy analysis function may be provided. In particular embodiments, the efficacy analysis function may be inferred by the first model 115.

In particular embodiments, the first computer system 110 may send the one or more execution flows corresponding to the agentic application to the second computer system 120 after associating a corresponding efficacy analysis function for each block and each group of blocks among selected groups of blocks. As an example and not by way of limitation, in stage 225, the manifest 210 including the one or more execution flows corresponding to the agentic application and efficacy analysis functions associated with selected subsets of blocks may be shared with the second computer system 120. Although this disclosure describes sending inferred one or more execution flows corresponding to an agentic application for review in a particular manner, this disclosure contemplates sending inferred one or more execution flows corresponding to an agentic application for review in any suitable manner.

In particular embodiments, a developer associated with the second computer system 120 may provide a confirmation on the execution flow corresponding to the agentic application. In particular embodiments, the developer associated with the second computer system 120 may modify a subset of the one or more execution flows before the developer sends the confirmation. In particular embodiments, the developer associated with a second computer system 120 may use one or more tools for processing the data corresponding to informal requirements for the agentic application to generate the plurality of requirements for the agentic application. The tools may include a large language model (LLM), an Integrated Development Environment (IDE), or an IDE assistant. As an example and not by way of limitation, the developer associated with the second computer system 120 may update the manifest 210 to detail and clarify inconsistencies, change requirements, select preferred APIs, agents, assistants, or sets of non-AI software components, indicate what efficacy tests are needed, and even change code in blocks (e.g., through an IDE). The developer may also initiate associating an efficacy analysis function with a group of blocks. When the manifest 210 is ready to be executed, the developer may provide a confirmation. When the manifest 210 is not ready to be executed, the developer may update the manifest 210 and post the manifest 210 with an indicator indicating that the manifest 210 is updated. By doing those, stages 221 through 225 may be repeated a number of times until the manifest 210 becomes ready to be executed. Although this disclosure describes interacting with a developer associated with a second computer system in a particular manner, this disclosure contemplates interacting with a developer associated with a second computer system in any suitable manner.

In particular embodiments, a second model trained to evaluate the one or more execution flows corresponding to the agentic application in relation to the plurality of requirements may provide the confirmation. As an example and not by way of limitation, an agent on the second computer system 120 may use a second model to evaluate the one or more execution flows and the efficacy analysis functions associated with the selected subsets of blocks in the manifest 210. The agent may provide the confirmation indicating that the manifest 210 corresponding the agentic application is ready to be executed. Although this disclosure describes getting a machine-learning model to evaluate the inferred one or more execution flows corresponding to an agentic application in relation to a plurality of requirements in a particular manner, this disclosure contemplates getting a machine-learning model to evaluate the inferred one or more execution flows corresponding to an agentic application in relation to a plurality of requirements in any suitable manner.

In particular embodiments, the first computer system 110 may cause the agentic application to be deployed upon receiving the confirmation from the second computer system 120. As an example and not by way of limitation, in stage 227, APIs, agents, assistants, or sets of non-AI software components addressed in the manifest 210 may be deployed within the agentic application runtime environment 130. The first computer system 110 may run the agentic application through the manifest 210. The manifest 210 may have been populated with one or more flows between start/end blocks, each of the blocks may contain the functional elements of the agentic application. For distributed agentic applications, multiple start/end blocks may be listed. The one or more flows may be materialized to real running code on real computers with Central Processing Units (CPUs), storage and Graphics Processing Units (GPUs). The agentic application runtime environment 130 may access the manifest 210 and may decide to run parts of the agentic application inside containers, serverless functions, use Software as a Service (SaaS) platforms, instantiate agents or assistant, interact with API services, and more. The agentic application runtime environment 130 may can use a series of back-ends for running the agentic application and may optimize for performance, data access, and other optimization constraints. The agentic application runtime environment 130 may insert methods to glue basic blocks together in the sequence of blocks, such as functions to perform API calls, to pass control between multiple threads, and to combine results, etc. When the agentic application runtime environment 130 cannot convert the manifest 210 to an executable agentic application, the agentic application runtime environment 130 may revert the manifest 210 with the reasons why the agentic application could not be executed. In such a scenario, stages 221 through 225 may be repeated to address the issues. Although this disclosure describes causing the agentic application to be deployed in a particular manner, this disclosure contemplates causing the agentic application to be deployed in any suitable manner.

In particular embodiments, the first computer system 110 may receive feedback generated based on operations of the deployed agentic application. In particular embodiments, the feedback may include efficacy measurements generated by the efficacy analysis functions. As an example and not by way of limitation, the efficacy analysis functions may add efficacy measurements into the manifest 210 while the agentic application is running. In stage 229, the first computer system 110 may receive the efficacy measurements in the manifest 210 and infer the effectiveness of the selected subsets of blocks and their associated artifacts including prompts, RAGs, configuration parameters based on the received efficacy measurements. The descriptions and all the artifacts used by the selected subsets of blocks and the inferred effectiveness may form a basis to the training set for the first model 115. In particular embodiments, the feedback may include structured feedback from one or more users of the deployed agentic application. As an example and not by way of limitation, one or more users of the deployed agentic application may also provide feedback in a pre-determined format. In particular embodiments, the pre-determined format may be binary for ‘good’ or ‘bad.’ The feedback from the one or more users may also for a basis to the training set for the first model 115. Although this disclosure describes receiving feedback on the deployed agentic application in a particular manner, this disclosure contemplates receiving feedback on the deployed agentic application in any suitable manner.

In particular embodiments, the first computer system 110 may retrain the first model 115 using at least the received feedback. In particular embodiments, retraining the first model 115 may include performing a reinforcement learning based on the received feedback. In particular embodiments, the reinforcement learning may be further based on feedback previously received. The retraining may improve the first model 115 to infer future agentic applications better. As an example and not by way of limitation, continuing with a prior example, in stage 231, the developer associated with the second computer system 120 may provide feedback on the effectiveness inferred in stage 229. Upon receiving a confirmation from the developer, the first computer system 110 may retrain the first model 115 using the received feedback. In particular embodiments, positive feedback may be used to reinforce mappings between requirements and blocks including mapping of AI agents or assistants. In particular embodiments, negative feedback may be used to deter the mappings from being inferred. When the first model 115 is well trained, a set of basic or aggregate blocks may be automatically inferred for new use cases. Thus, the first model may accelerate the development of agentic applications. Although this disclosure describes retraining a machine-learning model that infers one or more execution flows corresponding to the agentic application based on the plurality of requirements based on feedback on the deployed agentic application in a particular manner, this disclosure contemplates retraining a machine-learning model that infers one or more execution flows corresponding to the agentic application based on the plurality of requirements based on feedback on the deployed agentic application in any suitable manner.

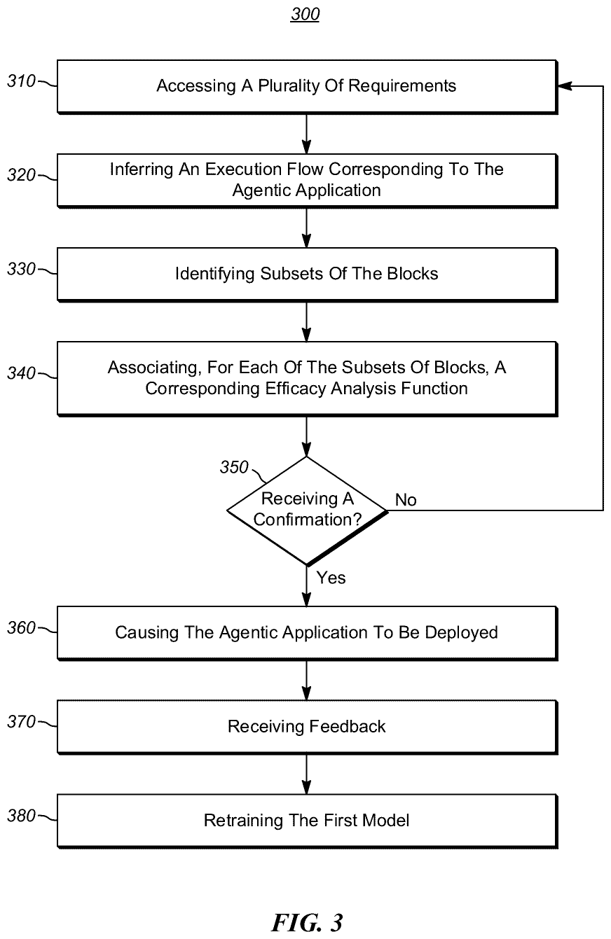

FIG. 3 illustrates an example method 300 for developing an agentic application using a machine-learning model. The method may begin at step 310, where a first computer system may access a plurality of requirements for an agentic application. At step 320, the first computer system may infer an execution flow corresponding to the agentic application based on the plurality of requirements using a pre-trained first model. The execution flow may include a sequence of blocks connected by a graph from a start block to an end block. Each of the blocks may be associated with an input, an output, and a functional intent achieved by an API, an AI agent, an AI assistant, or a non-AI software component that is interacting with another non-AI software components, an API, an AI agent, or an AI assistant. At step 330, the first computer system may identify subsets of the blocks that require corresponding efficacy measurement among the blocks belonging to the execution flow. The subsets of the blocks may include at least each individual blocks. At step 340, the first computer system may associate a corresponding efficacy analysis function with each of the subsets of the blocks. An efficacy analysis function may measure the efficacy of a corresponding subset of blocks. At step 350, the first computer system may determine whether the first computer system has received a confirmation on the execution flow corresponding to the agentic application. When the first computer system determines that the first computer system has received the confirmation on the execution flow corresponding to the agentic application, the method proceeds to step 360, where the first computer system may cause the agentic application to be deployed. When the first computer system determines that the first computer system has not received the confirmation on the execution flow corresponding to the agentic application, the method proceeds to step 310. At step 370, the first computer system may receive feedback generated based on operations of the deployed agentic application. At step 380, the first computer system may retrain the first model using at least the received feedback.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for developing an agentic application using a machine-learning model of the method of FIG. 3, this disclosure contemplates any suitable method for developing an agentic application using a machine-learning model including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

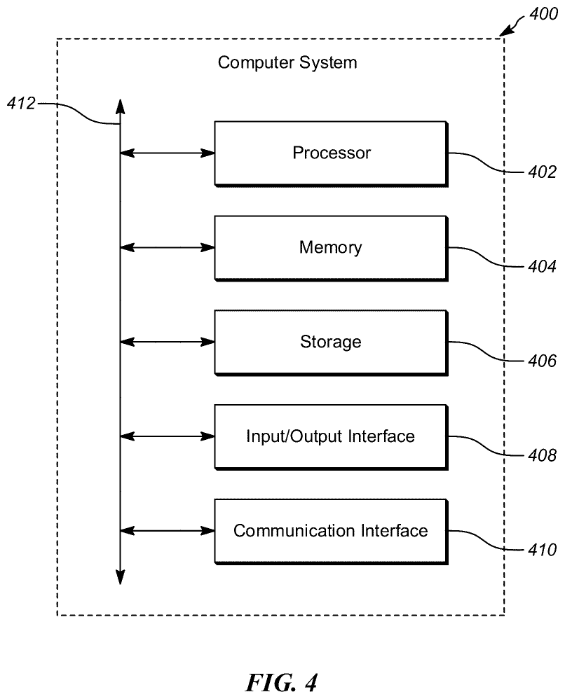

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a first computer system:
accessing a plurality of requirements for an agentic application;
inferring, using a pre-trained first model, an execution flow corresponding to the agentic application based on the plurality of requirements, wherein the execution flow comprises a sequence of blocks connected by a graph from a start block to an end block, wherein each of the blocks is associated with an input, an output, and a functional intent achieved by an application programming interface (API), an artificial intelligence (AI) agent, an AI assistant, or a non-AI software component that is interacting with another non-AI software component, an API, an AI agent, or an AI assistant;
identifying, among the blocks belonging to the execution flow, subsets of the blocks that require corresponding efficacy measurement, wherein the subsets of the blocks comprise at least each individual block;
associating, for each of the subsets of the blocks, a corresponding efficacy analysis function measuring efficacy;
causing the agentic application to be deployed;
receiving feedback generated based on operations of the deployed agentic application; and
retraining the pre-trained first model using at least the received feedback.

2. The method of claim 1, wherein the plurality of requirements for the agentic application is generated by processing data corresponding to informal requirements for the agentic application.

3. The method of claim 2, wherein the data corresponding to the informal requirements for the agentic application comprises notes, drawings, slides, formalized documents, compliance rules, or a piece of computer-interpretable code capturing proof-of-concept.

4. The method of claim 1, further comprising:
sending, to a second computer system, after associating, for each of the subsets of the blocks, the corresponding efficacy analysis function measuring the efficacy, the execution flow corresponding to the agentic application.

5. The method of claim 4, wherein causing the agentic application to be deployed is triggered upon receiving, from the second computer system, a confirmation.

6. The method of claim 5, wherein the execution flow is modified before the confirmation is received.

7. The method of claim 5, wherein a developer associated with the second computer system provides the confirmation.

8. The method of claim 7, wherein the developer associated with the second computer system uses one or more tools for interacting with the first computer system.

9. The method of claim 8, wherein the tools comprise a large language model (LLM), an Integrated Development Environment (IDE), or an IDE assistant.

10. The method of claim 5, wherein a second model trained to evaluate the execution flow corresponding to the agentic application in relation to the plurality of requirements provides the confirmation.

11. The method of claim 1, wherein an efficacy analysis function evaluates the functional intent for the corresponding subset of blocks.

12. The method of claim 1, wherein the feedback includes efficacy measurements generated by each of the efficacy analysis functions.

13. The method of claim 1, wherein the feedback includes structured feedback from one or more users of the deployed agentic application.

14. The method of claim 1, wherein retraining the pre-trained first model includes performing a reinforcement learning based on the received feedback.

15. The method of claim 14, wherein the reinforcement learning is further based on feedback previously received.

16. A first computer system comprising:
one or more processors; and
one or more computer-readable non-transitory storage media coupled to one or more of the processors and comprising instructions operable when executed by one or more of the processors to:
access a plurality of requirements for an agentic application;
infer, using a pre-trained first model, an execution flow corresponding to the agentic application based on the plurality of requirements, wherein the execution flow comprises a sequence of blocks connected by a graph from a start block to an end block, wherein each of the blocks is associated with an input, an output, and a functional intent achieved by an application programming interface (API), an artificial intelligence (AI) agent, an AI assistant, or a non-AI software component that is interacting with another non-AI software component, an API, an AI agent, or an AI assistant;
identify, among the blocks belonging to the execution flow, subsets of the blocks that require corresponding efficacy measurement, wherein the subsets of the blocks comprise at least each individual block;
associate, for each of the subsets of the blocks, a corresponding efficacy analysis function measuring efficacy;
cause the agentic application to be deployed;
receive feedback generated based on operations of the deployed agentic application; and
retrain the pre-trained first model using at least the received feedback.

17. The first computer system of claim 16, wherein the plurality of requirements for the agentic application is generated by processing data corresponding to informal requirements for the agentic application.

18. The first computer system of claim 17, wherein the data corresponding to the informal requirements for the agentic application comprises notes, drawings, slides, formalized documents, compliance rules, or a piece of computer-interpretable code capturing proof-of-concept.

19. The first computer system of claim 16, wherein the one or more processors are further operable when executing the instructions to:
send, to a second computer system, after associating, for each of the subsets of the blocks, the corresponding efficacy analysis function measuring the efficacy, the execution flow corresponding to the agentic application.

20. One or more computer-readable non-transitory storage media embodying software that is operable when executed by a cloud management system to:
access a plurality of requirements for an agentic application;
infer, using a pre-trained first model, an execution flow corresponding to the agentic application based on the plurality of requirements, wherein the execution flow comprises a sequence of blocks connected by a graph from a start block to an end block, wherein each of the blocks is associated with an input, an output, and a functional intent achieved by an application programming interface (API), an artificial intelligence (AI) agent, an AI assistant, or a non-AI software component that is interacting with another non-AI software component, an API, an AI agent, or an AI assistant;
identify, among the blocks belonging to the execution flow, subsets of the blocks that require corresponding efficacy measurement, wherein the subsets of the blocks comprise at least each individual block;
associate, for each of the subsets of the blocks, a corresponding efficacy analysis function measuring efficacy;
cause the agentic application to be deployed;
receive feedback generated based on operations of the deployed agentic application; and
retrain the pre-trained first model using at least the received feedback.
